(19) United States
(12) Patent Application Publication
(10) Pub. No.: US 2012/0100513 A1
(43) Pub. Date: Apr. 26, 2012

(54) SIMULATED BODY PANEL SYSTEM

(75) Inventors: Gary M. Simecek, Avon Lake, OH (US); Gary J. Billington, Avon Lake, OH (US)

(73) Assignee: Q-Lab Corporation

(21) Appl. No.: 13/227,172

(22) Filed: Sep. 7, 2011

Related U.S. Application Data
(60) Provisional application No. 61/394,975, filed on Oct. 20, 2010.

(51) Int. Cl. G09B 19/00; G09B 9/00

(52) U.S. Cl. 434/219

(57) ABSTRACT

A simulated body panel system is provided for aiding a person to learn how to paint a vehicle and for testing new paints and their spray application. The simulated body panel system includes a frame and a relatively thin and flexible body panel incapable of self support. The frame includes a front end, a rear end, a first side, a second side, and a panel support member mounted to the frame. The flexible body panel incapable of self support includes a top face and a bottom face. The body panel can be selectively mounted to and supported by the frame, wherein the body panel bottom face contacts and is supported by the panel support member.

This application claims priority to U.S. Provisional Application Ser. No. 61/394,975 which was filed on Oct. 20, 2010. The subject matter of that application is incorporated hereinto in its entirety.

### BACKGROUND

The present exemplary embodiment relates to simulated body panels and a system for their support. It finds particular application in conjunction with training painters at auto refinish shops and provides a means for auto refinish paint developers to try out new paint formulations and to perfect the application of spray paints to a vehicle surface, and will be described with particular reference thereto. However, it is to be appreciated that the present exemplary embodiment is also amenable to other like applications.

Paint manufacturers use real vehicle fenders and hoods as a paint substrate during their own product development. Similarly, in auto refinish shops painters are trained using real fenders and hoods. In both cases a rolling cart or other support structure is required to support the fenders and hoods, which must be bolted or otherwise affixed to the cart or other support structure. This has several disadvantages, as real fenders and hoods are expensive, heavy, require large amounts of space for storage, and require labor to bolt and unbolt the fenders and hoods.

It would be advantageous to provide an alternative to real fenders and hoods for training painters and testing new paints and their spray application. Such an alternative should be relatively light weight, inexpensive, require little labor, and require less space for storage.

### BRIEF DESCRIPTION

The present application relates to a simulated body panel system. The system includes a simulated hood and two fenders as a realistic mock-up of the “Front Clip” or front end of a car or other vehicle. The faux “Front Clip” is a simplified version of the real thing. But, it has all of the essential difficulties of painting body panel elements: seams, edges, corners, holes, vertical and horizontal surfaces. A support structure, such as a cart, holds panel members that are more or less in the shape of a hood and fenders of a vehicle. The simulated fenders and hoods simply rest on and conform to the shape of the underlying support member. This allows the panels to be much thinner and lighter weight than real fenders and hoods, which have to be strong enough to support themselves. The faux pieces are so thin that a strong rigid support is required for them to rest against in order to maintain the correct shape. The simulated body panels can be designed to be mounted to the support structure without the use of any tools or bolts.

In accordance with one aspect of the present disclosure, a simulated body panel system comprises a frame and a relatively thin and flexible body panel incapable of self support. The frame includes a front end, a rear end, a first side, a second side, and a panel support member mounted to the frame. The body panel comprises a top face and a bottom face. The body panel is capable of being mounted to and supported by the frame, wherein the body panel bottom face contacts and is supported by the panel support member.

In accordance with another aspect of the present disclosure, a simulated body panel system which aids in learning how to spray paint vehicle body panels and testing new paints and their spray application is disclosed. The system comprises a support frame, a practice, relatively thin and flexible, body panel incapable of self support, and cooperating connecting members. The cooperating connecting members are mounted on the support frame and the practice body panel to enable the practice body panel to be selectively mounted to and detached from the support frame without tools.

In accordance with a further aspect of the present disclosure, a simulated vehicle front end for aiding a person to learn how to paint a vehicle and testing new paints and their spray application is disclosed. The front end comprises a saddle including a frame defining a generally horizontal surface flanked by a pair of generally vertical surfaces. The frame further includes a front end and a rear end, wherein the rear end is located at a higher elevation than is the front end when the saddle is held on a subjacent surface to mimic a sloping vehicle front end. The test hood is selectively supported on the generally horizontal surface of the saddle. The first and second test fenders are supported on a respective one of the pair of vertical surfaces. The test hood and the first and second test fenders are relatively thin and flexible so that they are not self supporting and are supported by a respective portion of the saddle.

### BRIEF DESCRIPTION OF THE DRAWINGS

The disclosure may take form in various components and arrangements of components as will be pointed out more fully hereinafter in conjunction with the written description of the preferred embodiments and illustrated in the accompanying drawings in which:

FIG. 1 is an exploded perspective view of a simulated body panel system with several test body panels detached from a support cart or saddle according to one embodiment of the present disclosure;

FIG. 2 is an exploded perspective view of the simulated body panel system of FIG. 1 with both the panel support members and test body panels detached from a frame;

FIG. 3 is an enlarged front elevational view of the cart of FIG. 1;

FIG. 4 is a reduced side elevational view of the cart of FIG. 3;

FIG. 5 is a greatly enlarged front elevational view of a portion of the support cart and the body panels of FIG. 1 illustrating the mounting of the body panels to the support cart;

FIG. 6 is a reduced perspective view of the central and lateral body panel mounted to the support frame of FIG. 5;

FIG. 7 is a perspective view of a simulated body panel system support structure according to another embodiment of the present disclosure; and

FIG. 8 is a perspective view of a simulated body panel system support structure according to yet another embodiment of the present disclosure.

### DETAILED DESCRIPTION

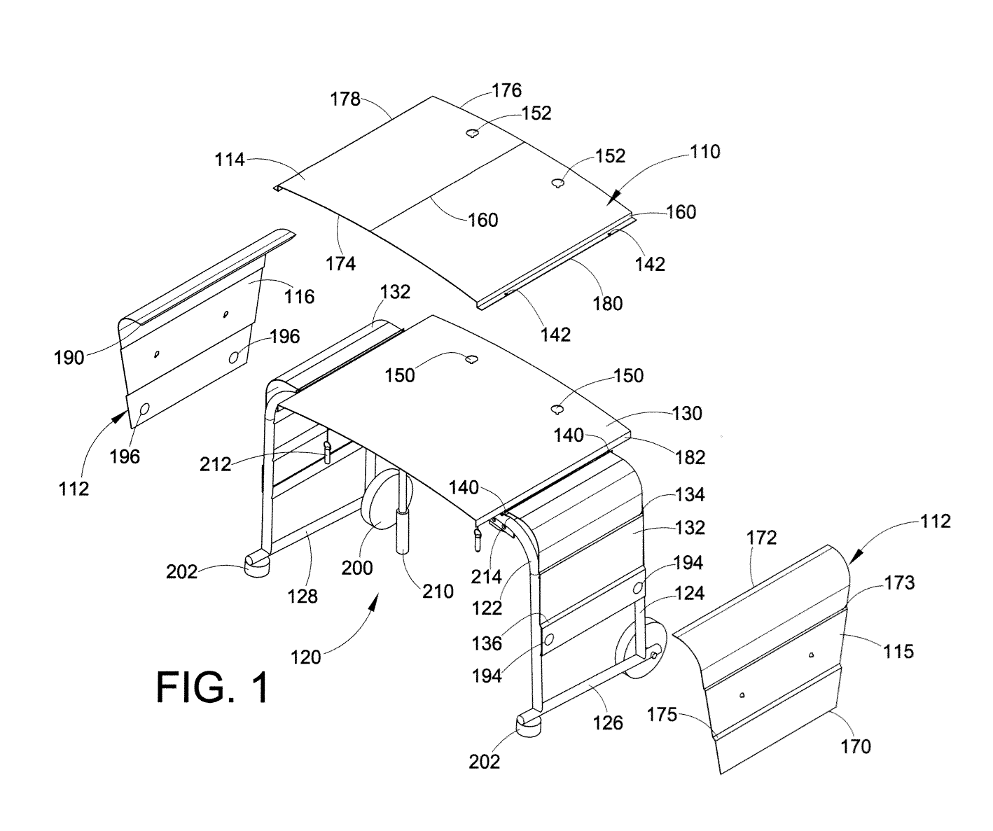

Referring now in greater detail to the drawings wherein the showings are for purposes of illustrating several embodiments of the disclosure only and not for limiting same. FIG. 1 depicts one embodiment of a simulated body panel system for aiding in the teaching of painting vehicle body panels and for testing new paints and their spray application. In this embodiment, the simulated body panel system includes a support frame or saddle 120 to which are mounted a horizontal support member or saddle hood 130 and two vertical support members or saddle fenders 132. The support frame 120 includes a front end 122, a rear end 124, a first side 126, and a second side 128. The rear end 124 of the support frame 120 is elevated in relation to the front end 122, such that the horizontal support member or saddlehood 130 slopes towards the front end 122 of the support frame 120, as does a vehicle's front end. The sloping is best illustrated in FIG. 4. The horizontal support member 130 comprises an approximately horizontal surface and a first side edge 182.

A central body panel or test hood 110 and two lateral body panels or test fenders 112 are shown in a detached position from the saddle 120. The body panels 110, 112 are relatively thin and flexible. Thus, they are not capable of self support. In other words, they are too thin to support themselves and would buckle but for the support provided by the saddle, cart or support member on which they are mounted. To this end, in one embodiment, the simulated vehicle body panels can be made of a relatively thin (for example, from 0.020 to 0.040 inches or 0.508 to 1.016 mm) metal sheet (such as aluminum or the like). In another embodiment, the metal sheet can be about 0.015 inches or 0.381 mm in thickness. Of course, other dimensions for the thickness of the metal sheet are also contemplated. As noted, the panels can be simply planar metal sheets of generally constant thickness. In contrast, real body panels of vehicles, since they have to be self-supporting, are three dimensional objects with significant depth. As a result, they are much heavier than the test panels disclosed herein.

As a result of the fact that the body panels are merely planar sheets, they are relatively inexpensive to produce and can, therefore, be single use objects. Thus, after painting, the panels can be disposed of or recycled and replaced with fresh panels. One advantage of the simulated body panels disclosed herein is that the panels can be relatively consistent in size and shape, as opposed to real body panels which vary depending on the vehicle they are made for. Further, unlike real body panels which may have to be retrieved from junkyards for the training or testing purposes disclosed herein, the simulated vehicle body panels described herein can be purpose made. Thus, new panels are made available for testing new paints and their spray application, training painters in body shops and the like, rather than having to use old vehicle body panels which likely have surfaces aged by exposure to the elements.

The central body panel or test hood 110 is comprised of a top face 114, a bottom face (not visible), a ridge 160 centrally located along the top face 114, a front edge 174, a rear edge 176, a first side edge 178, and a second side edge 180. The two lateral body panels or test fenders 112 are comprised of a top face 115, a bottom face 116, a top edge 172 and a bottom edge 170. Also illustrated are a pair of ridges 173 and 175 in order to more closely simulate the fenders of a vehicle, and enable the painter to learn how to spray paint a vehicle body panel including at least one such ridge.

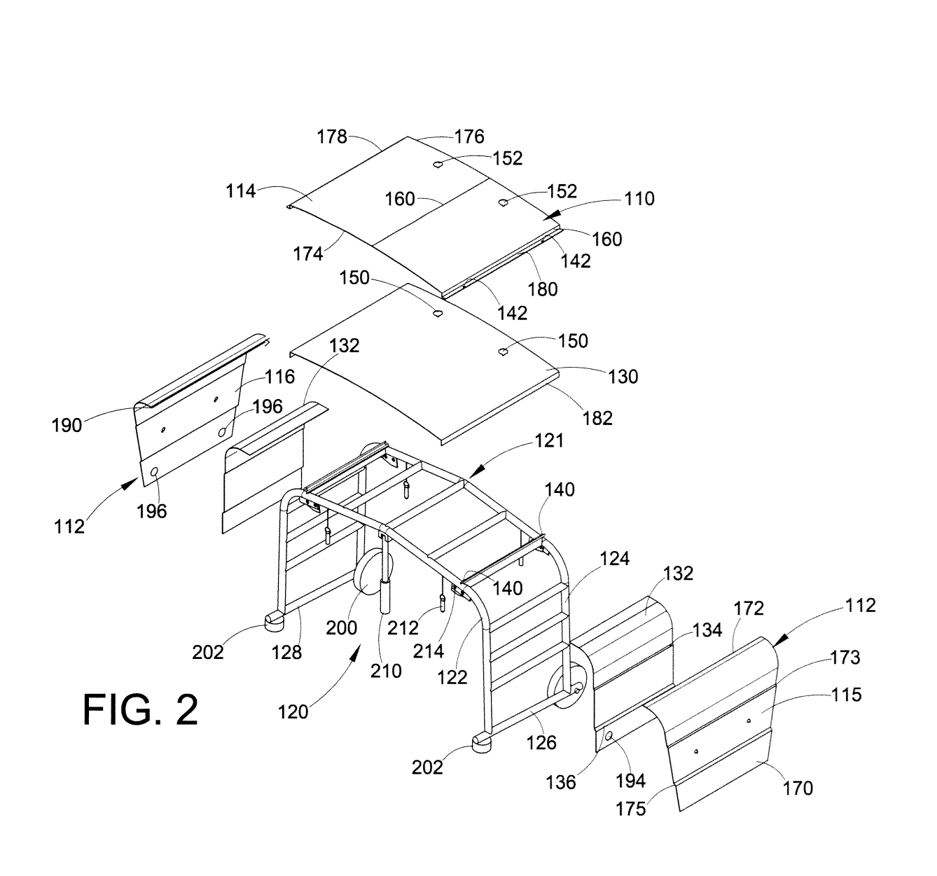

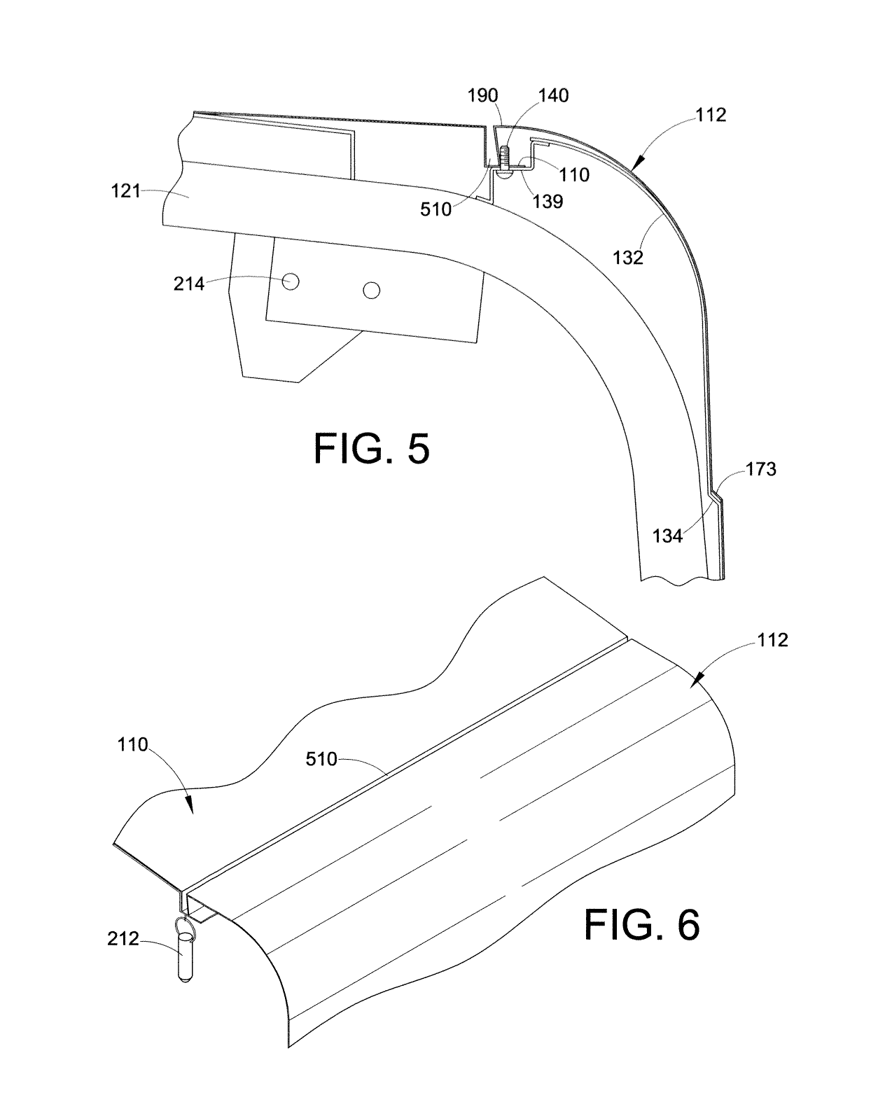

The central 110 and lateral body panels 112 can be mounted to and supported by the cart or saddle 120. The central body panel 110 is mounted to the saddle 120 by inserting studs 140 held on the saddle 120 through mounting holes 142 located in flanges positioned along the side edges of the body panel or test hood 110. As best shown in FIG. 5, the studs 140 can be mounted on a somewhat Z-shaped top angle 139 that is affixed to a frame 121, such as by welding. See also FIG. 2. When the central body panel 110 is mounted, the body panel bottom face 116 is in contact with and supported by the horizontal support member or saddle hood 130. The horizontal support member 130 contains holes 150, such that when the central body panel or test hood 110 is mounted the holes 150 overlap with holes 152 defined in the central body panel 110. Similar holes can be provided in the two lateral body panels, as illustrated in FIGS. 1 and 2. The purpose for the holes is to allow the painter to learn how to spray paint a vehicle body panel which includes at least one hole.

The lateral body panels or test fenders 112 are mounted to the cart or saddle 120 by hanging the panels from the studs 140 using a flange 190 extending along the top edge 172 of the body panels 112. The flange 190 is oriented approximately parallel to the bottom face 116 of the lateral body panel 112 and overlies a portion of the lateral body panel 112. The flange 190 hooks over the studs 140 on the support frame 120 such that the lateral body panel 112 hangs from the stud 140 and rests against the lateral support surface 132. Two mounting tabs 194 on the vertical support member 132 cooperate with a corresponding mounting tabs 196 located on the rear face of the at least one lateral body panel 112 to more securely mount the body panel 112. The mounting tabs can be made of a hook and loop material such as Velcro, if so desired.

The cart or saddle 120 in the embodiment shown includes two wheels 200 attached to the rear end 124 of the frame 121 to allow easy movement of the system. Two pads or bumpers 202 are attached to the front end 122 of the frame 121 so as to provide a stable base for the system when stationary. The wheels 200 and pads or bumpers 202 can comprise rubber or another suitable material. A pivotable handle 210 is attached to the frame 121 to allow easier control of the system during movement. The handle 210 can be pivoted to a generally horizontal orientation for use when moving the cart from one location to another. When not needed, however, the handle can pivot out of the way by gravity.

Fastener members 212 are inserted into aligned fastener apertures 214 provided in tabs of the frame to hold the frame 121 in an extended position, as depicted in FIG. 1. The fastener members 212 can be removed in order to collapse the frame 121 (not shown) for storage and can again be inserted into the fastener apertures 214 in order to hold the frame 121 in the collapsed position. Thus, the saddle 120 can be selectively collapsed when so desired. It is apparent that the fasteners 212 can be suspended by cords or the like from the frame.

With reference to FIG. 2, the horizontal 130 and vertical 132 support members or saddle hood and fenders are shown detached from the frame 121. The detached support members 130, 132 allow for the tubular structure of the frame 121 to be visualized. The support members can be made of planar metal sections and can be welded onto the frame 121, if so desired.

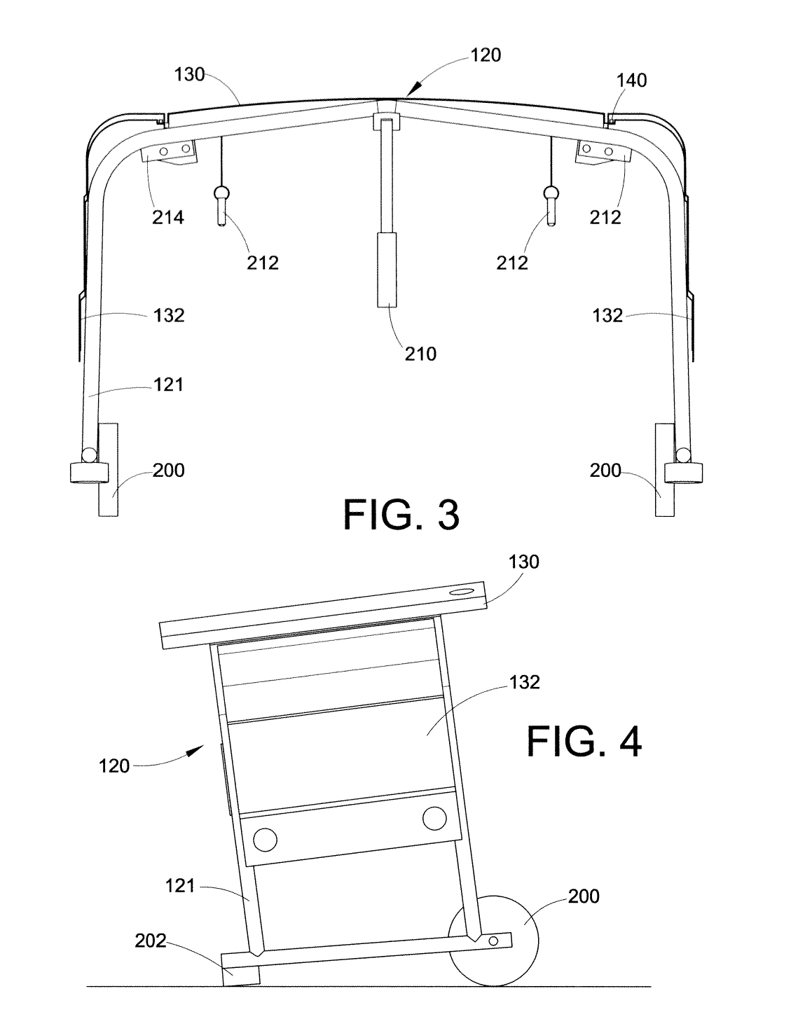

With reference now to FIG. 3, a front view of the support cart of the simulated body panel system of FIG. 1 is shown. This view depicts where the horizontal 130 and vertical support members 132 are located in relation to the frame 121. The various elements of the support cart can be more easily visualized in FIG. 3. It should be apparent from FIGS. 3 and 4 that the cart 120 is meant to simulate the front end of a motor vehicle, such as a car or truck. The studs 140 and tabs 132 are clearly depicted. These enable the simulated body panels to be readily attached to or detached from the support cart or saddle 120 without the need to resort to tools. As such, the process of replacing the simulated body panels is greatly sped up.

With reference now to FIG. 4, a side view of the simulated body panel system of FIG. 1 is shown. The side view depicts the system in a stationary position with the slope of the horizontal support panel 130 clearly visible.

With reference now to FIG. 5, an enlarged front view of the mounting of the central 110 and lateral 112 body panels or test hood and fenders to the support frame or saddle 120 is shown. As described previously, the central body panel 110 is mounted to the saddle 120 via the studs 140 held on the angle 139 mounted to the frame 121, such that the studs extend through the mounting holes 142 located along the side edges of the test hood or central body panel 110 when the body panel is lowered onto the saddle. The lateral body panels or test fenders 112 are mounted to the saddle 120 by hanging the panels from the studs 140 using the flange 190 extending along the top edge 172 of the body panels 112. The flange 190 hooks over the studs 140 on the saddle 120 such that the lateral body panel 112 hangs from the stud 140 and rests against the lateral support surface 132. The ridge 173 of the lateral body panel 112 is supported by the corresponding ridge 134 of the vertical support member 132. At this time, the two mounting tabs 194 and 196, shown in FIG. 2, for example, contact each other in order to hold the lower sections of the two side body panels in place. This enables the central 110 and lateral body panels 112 to be mounted to and detached from the saddle without tools.

With reference now to FIG. 6, an enlarged perspective view of a portion of the test panels 110, 112 mounted to the saddle is shown. In order to produce a realistic practice surface, a gap 510 is defined between the test hood 110 and the test fenders 112 as would be found on a real car or other vehicle. To this end a gap 510 of generally constant width is present between each side edge 178, 180 of the mounted test hood 110 and the top edge 172 of the mounted test fender 112.

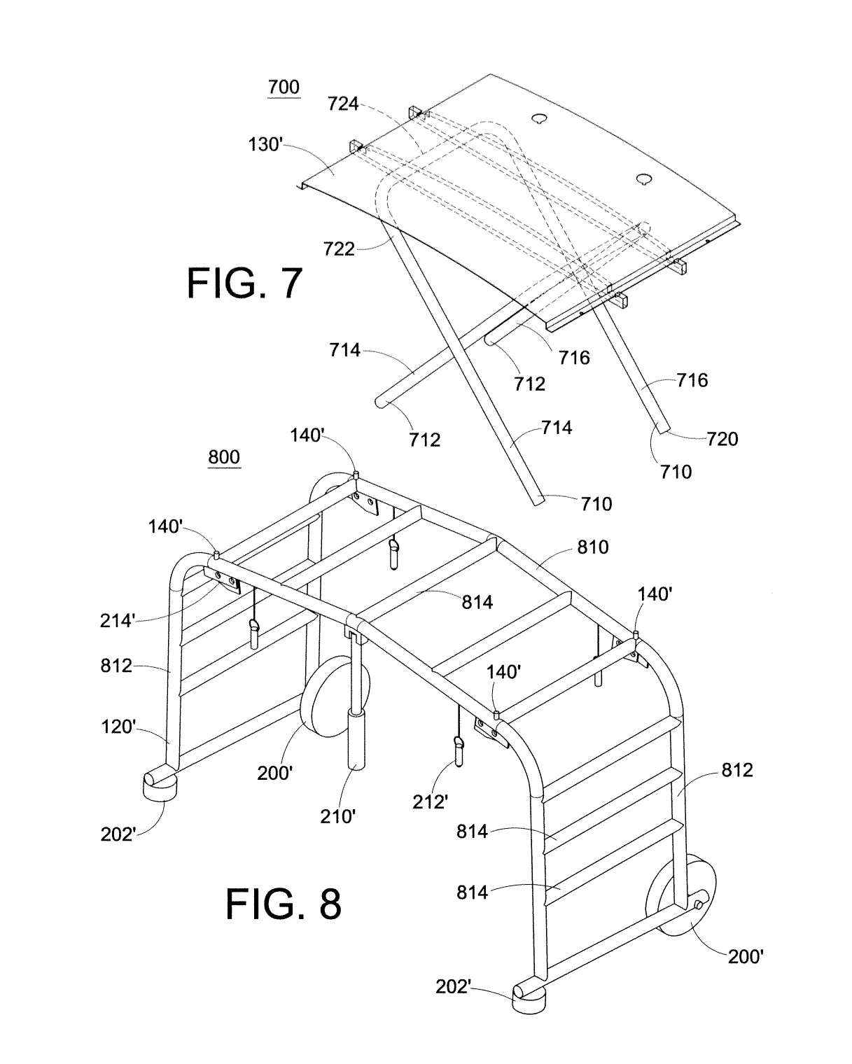

With reference now to FIG. 7, another embodiment of a support structure for a simulated body panel system is shown. In this embodiment, there is only a horizontal support panel 130′. The horizontal support panel 130′ is mounted on and supported by a frame comprised of a first support stand 710 and a second support stand 712. The support stands 710, 712 are comprised of two approximately parallel legs 714, 716 having a top end 722 and a bottom end 720. The top end 722 of the legs are connected by a connecting member 724 that is oriented approximately perpendicular to the legs 714, 716. Each leg of the first support stand 710 is rotationally engaged to one leg of the second support stand 712. This allows the frame to be collapsed (not shown) for storage or expanded for use. If painting practice on only a test hood or central body panel or hood is desired, the support structure 700 allows such practice to take place without the need to employ the cart illustrated in the previous embodiment.

With reference now to FIG. 8, yet another embodiment of the simulated body panel system is shown. This embodiment includes a support frame or saddle 800 but without the provision of the horizontal and vertical support members shown in the embodiment of FIGS. 1-6. In this embodiment, central and lateral body panels, as in FIGS. 1 and 2, are supported directly by the support frame 800. Taking the place of the horizontal and vertical support members are a generally horizontally oriented surface 810 flanked by a pair of generally vertically oriented surfaces 812 defined on the support frame 800. The support surfaces are defined by the several tubular members 814 which form the frame of the support cart illustrated. Alternatively, one or more planar support elements (not illustrated) can cooperate with the tubular members to define at least one of the generally horizontal oriented surface and the pair of generally vertically oriented surfaces. The frame further includes a front end 122′ and a rear end 124′. If so desired, the rear end 124′ can be located at a higher elevation than the front end 122′. The resulting slope of the generally horizontal surface 810 would mimic a sloping vehicle front end.

The body panels can be mounted in the same manner as FIG. 1 using mounting studs 140′ and cooperating mounting holes on the central body panel. Similarly, flanges can be provided on the side body panels. The cooperating connecting members enable the central and side body panels or test panels to be mounted on and detached from the support frame without tools.

The instant disclosure has been described with reference to several embodiments. Obviously, modifications and alterations will occur to others upon reading and understanding the preceding detailed description. It is intended that the disclosure be construed as including all such modifications and alterations insofar as they come within the scope of the appended claims or the equivalents thereof.

1. A simulated body panel system comprising:
a frame including a front end, a rear end, a first side, a second side, and a panel support member mounted to the frame; and,
a relatively thin and flexible body panel incapable of self support, comprising a top face, and a bottom face, the body panel capable of being selectively mounted to and supported by the frame, wherein the body panel bottom face contacts and is supported by the panel support member.

2. The simulated body panel system of claim 1, wherein the panel support member comprises an approximately horizontal surface, the rear end of the support frame being elevated to a height greater than the front end thereof such that the horizontal support surface slopes towards the front end of the frame.

3. The simulated body panel system of claim 1, wherein the frame includes at least one stud; the body panel including at least one mounting hole through which the at least one stud protrudes to mount the body panel to the frame.

4. The simulated body panel system of claim 1, wherein the panel support member further comprises at least one hole; the body panel further comprises at least one hole; and the support member hole generally overlaps the body panel hole when the body panel is mounted to the frame.

5. The simulated body panel system of claim 1, wherein the body panel includes at least one ridge located along the top face.

6. The simulated body panel system of claim 1, wherein the support member comprises an approximately horizontal support member, and, spaced therefrom, at least one approximately vertical support member; and wherein
the body panel comprises:
at least one lateral body panel having a top edge and a bottom edge; and
a central body panel, having a front edge, a rear edge, a first side edge, and a second side edge.

7. The simulated body panel system of claim 6, wherein the frame includes at least one stud;
the central body panel including at least one mounting hole through which the at least one stud protrudes when mounting the central body panel to the frame.

8. The simulated body panel system of claim 7, wherein the at least one lateral body panel includes a flange extending along the top edge, the flange being oriented approximately parallel to a portion of the lateral body panel.

9. The simulated body panel system of claim 8, wherein the flange hooks over the at least one stud such that the lateral body panel hangs from the stud and rests against the lateral support surface of the frame.

10. The simulated body panel system of claim 9, wherein a gap defined between one side edge of the mounted central body panel and the top edge of the mounted lateral body panel has a consistent width.

11. The simulated body panel system of claim 6, wherein the at least one approximately vertical support member includes a mounting tab that cooperates with a corresponding mounting tab located on the rear face of the at least one lateral body panel to mount the body panel to the panel support member.

12. The simulated body panel system of claim 6, the frame further includes at least one wheel and at least one pad.

13. The simulated body panel system of claim 12, wherein the at least one wheel is attached to the rear end of the frame and the at least one pad is attached to the front end thereof.

14. The simulated body panel system of claim 1, wherein the frame comprises a first support stand and a second support stand; each support stand comprising two approximately parallel legs having a top end and a bottom end; the top end of the legs connected by a connecting member oriented approximately perpendicular to the legs; each leg of the first support stand being rotationally engaged to one leg of the second support stand; wherein the frame has a collapsed and an expanded position.

15. The simulated body panel system of claim 1, wherein the flexible body panel incapable of self support has a maximum thickness of 0.040 inches.

16. A simulated body panel system for aiding to learn how to spray paint vehicle body panels and testing new paints and their spray application, the system comprising:
a support frame;
a relatively thin and flexible practice body panel incapable of self support; and
cooperating connecting members mounted on the support frame and the practice body panel to enable the practice body panel to be selectively mounted to and detached from the support frame without tools.

17. The system of claim 16, wherein the support frame comprises a plurality of tubular legs.

18. The system of claim 17, wherein the support frame further comprises at least one panel support member mounted to at least some of the plurality of tubular support legs.

19. The system of claim 18, wherein an approximately horizontal panel support member is flanked by a pair of approximately vertical support members.

20. A simulated vehicle front end for aiding a person to learn how to paint a vehicle and testing new paints and their spray application, the front end comprising:
a saddle including a frame defining a generally horizontal surface flanked by a pair of generally vertical surfaces, the frame further including a front end and a rear end, wherein the rear end is located at a higher elevation than is the front end when the saddle is held on a subjacent surface to mimic a sloping vehicle front end;
a test hood selectively supported on the generally horizontal surface of the saddle;
first and second test fenders supported on a respective one of the pair of generally vertical surfaces; and
wherein the test hood and the first and second test fenders are relatively thin and flexible so that they are not self supporting and are supported by a respective portion of the saddle.

21. The simulated front end of claim 20, further comprising cooperating connecting members located on the saddle and on the test hood and the first and second test fenders, the cooperating connecting members enabling the test hood and test fenders to be selectively mounted on and detached from the saddle without tools.
